(19) United States
(12) Patent Application Publication
(10) Pub. No.: US 2008/0017307 A1
(43) Pub. Date: Jan. 24, 2008

(54) ANTIMICROBIAL OVERLAY SHEET AND METHOD

(75) Inventors: Ivan Wei-Kang Ong, Charlotte, NC (US); William D. Hanrahan, Charlotte, NC (US)

Correspondence Address: CLIFF D. WESTON;MICROBAN PRODUCTS COMPANY, 1115 VANSTORY DRIVE, SUITE 125, HUNTERSVILLE, NC, 28078, US

(73) Assignee: MICROBAN PRODUCTS COMPANY, HUNTERSVILLE, NC (US)

(21) Appl. No.: 11/549,145

(22) Filed: Oct. 13, 2006

Related U.S. Application Data
(63) Continuation-in-part of application No. 11/268,023, filed on Nov. 7, 2005.
(63) Continuation-in-part of application No. 10/521,987, filed on Jan. 21, 2005.
(63) Continuation-in-part of application No. 10/484,666, filed on Feb. 7, 2005.

(51) Int. Cl. B32B 27/42; B32B 27/10

(52) U.S. Cl. 156/307.1; 428/530; 428/906

(57) ABSTRACT

An overlay component has an antimicrobial melamine resin including an antimicrobial agent incorporated therein. The overlay component is useful for making melamine-surfaced laminate articles having a tough, mar-resistant surface exhibiting antimicrobial properties.

### CROSS-REFERENCES TO RELATED APPLICATION

This application is a continuation-in-part of U.S. Ser. No. 11/268,023, filed on Nov. 7, 2005, U.S. Ser. No. 10/521,987, filed on 21 Jan. 2005, and U.S. Ser. No. 10/484,666, filed on Nov. 23, 2004, the disclosures of which are incorporated by reference herein in their entireties for all purposes.

### BACKGROUND OF THE INVENTION

1) Field of the Invention

The present invention relates to an antimicrobial melamine resin, and more particularly to a melamine resin having therein an antimicrobial agent and the surface coatings, decorative laminates and molded articles that can be formed therewith.

2) Prior Art

Melamine resins are widely used for surface coatings and decorative laminates, such as paper-based and wood-based laminates. Melamine resins have one of the hardest surfaces of any commercial material. Native hardness, along with excellent grease and water resistance, low flammability, and clarity of the plastic, has led to the usefulness of melamine formaldehyde as a surface coating.

Melamine (C₃H₆N₆; CAS No. 108-78-1) is a white crystalline solid. Combining it with formaldehyde results in the formation of a compound referred to as a methylol derivative. With additional formaldehyde, the melamine reacts to form tri-, tetra-, penta-, and hexa-methylol melamine. While commercial melamine resins may be obtained without the use of catalyst, both heating and catalyst are used to speed polymerization and curing.

Decorative laminates are usually assembled with a core of one or several sheets of phenolic or melamine resin impregnated kraft paper. The core conventionally is surfaced with a melamine formaldehyde impregnated sheet, which is often printed with a decorative design. Finally, a thin melamine resin-impregnated overlay sheet is applied. The sheets can be impregnated by being passed through a resin bath, and followed by controlled moisture drying.

Melamine coating typically is employed in furniture and flooring products. For example, a flooring article can have a top layer of melamine formaldehyde that is heated under pressure to fuse to a wood layer or other substrate. The top layer is highly resistant to scuffs, stains, and wear, yet transparent to allow the wood grain (real or simulated) to show through.

The overlay material generally is between two to four millimeters thick, perhaps two meters in width, and can be sold as a roll in lengths as desired. The roll sheet can be adhesively bonded to a substrate (e.g., wooden base) to make countertop, flooring, furniture, etc.

Although melamine resin and its uses are known to those skilled in the art, it has proven quite difficult to produce a melamine resin having antimicrobial properties, as opposed to a topical treatment that only has a temporary, relatively short-lived duration. A technical complication to antimicrobial solutions is that melamine resin most usually contains formaldehyde, which interferes with most antimicrobial chemistries. Certain classes of antimicrobial agents may react with or otherwise be assimilated into the melamine and/or melamine-formaldehyde, such that the antimicrobial agents are incorporated into the resin and no longer exhibit antimicrobial properties.

Antibacterial phosphate cocktails have been employed, such as antibacterial phosphates combined with silver, benzalkonium, cetypiridinium and isopropylmethylphenol (Japan Publication JP 07-329265). This antibacterial mixture is added both to the overlay sheet (or the printed sheet) and to the underlying kraft paper, the latter then being impregnated with phenolic resins.

The use of phosphates is disadvantageous in that it requires a secondary antimicrobial, in part because phosphates are themselves a food source for a number of elemental plants and animals (bacteria and fungi).

### DESCRIPTION OF THE PREFERRED EMBODIMENTS

In the broadest sense, the present antimicrobial melamine resin is a curably permanent resin comprising melamine and an antimicrobial agent. The antimicrobial agent is substantially inert with respect to the melamine resin and present within the melamine resin in an amount effective to provide antimicrobial properties. An antimicrobial agent is substantially uniformly dispersed within the resin, such that an article manufactured using the antimicrobial melamine exhibits antimicrobial properties for the useful life of the melamine layer.

The curing of melamine resins is quickened by the use of heat and acid catalyst, while the overall pH is usually neutral or slightly alkaline. The addition of acid catalyst provides a source for protons, but the level of addition is generally kept lower than alkalinity produced by the amines.

The present antimicrobial melamine resin contemplates a resin of melamine; alkylated melamines such as methylated melamines, butylated melamines, or isobutylated melamines; melamines containing imino resins such as methylated imino resins, butylated imino resins, or isobutylated imino resins; urea resins such as methylated urea resins, butylated urea resins, isobutylated urea resins; formaldehyde resins; benzoguanamine resins; and glycoluril resins. Those with skill in the melamine art will recognize that additional melamine resin bases can be employed in the production of a melamine surfaced article.

Effective antimicrobial agents preferably are those with relatively low vapor pressures. Triclosan (2,4,4′-trichloro-2′-hydroxydiphenyl ether), which is particularly efficacious, has a vapor pressure of 4×10⁻⁴ mm at 20° C. On the other hand, ortho phenyl phenol (OPP; CAS No. 90-43-7), which has a boiling point of 280° C., is generally considered too volatile to be employed except in applications necessitating superior resistance to bio-fouling. The combination of OPP and triclosan has been found to exhibit synergistic effects and, in products having a melamine formaldehyde coating where anti-bio fouling properties is desired, the use of OPP can be justified.

Other efficacious antimicrobial agents include isothiazolone-based compounds, such as 1,2-benzisothiazolin-3-one (CAS No. 2634-33-5); N-butyl-1,2-benzisothiazolin-3-one (BBIT; CAS No. 4299-07-4); 2-octyl-isothiazolone (CAS No. 26530-20-1); 4,5-dichloro-2-N-octyl-3(2H)-isothiazolone (CAS No. 64359-81-5); methyl-3(2H)-isothiazolone (CAS No. 2682-20-4); and chloro-2-methyl-3(2H)-isothiazolone (CAS No. 26172-55-4).

Additional antimicrobial agents suitable for use in the melamine resin disclosed herein include diiodomethyl p-tolylsulfone (CAS No. 20018-09-1); zinc and sodium pyrithiones (e.g. CAS No. 13463-41-7); azoles (such as propiconazoles), polyhexamethylene biguanide hydrochloride (e.g. CAS No. 32289-58-0); 3,4,4′-trichlorocarbanilide (CAS No.101-20-2); titanium dioxide; and barium metaborate (CAS No. 26124-86-7).

Silver, copper or zinc can also be used in various forms, such as in zeolite or amorphous glass powder. Silver, for example, alternatively may be utilized in the present melamine resin in elemental form or in sol/gel form; the general concept being that the inorganic antimicrobial be disposed in the melamine resin product in an ion exchangeable form.

In some cases, it may be desirable to add a dispersing agent with the antimicrobial agent to prevent agglomeration of the antimicrobial agent in the melamine resin.

The antimicrobial agent(s) is/are dispersed in the melamine resin bath prior to impregnation of kraft paper or molding of an article. As one example, the antimicrobial agent may be delivered as a fine divided powder diluted in a liquid forming a dispersion, which can be admixed with the melamine formaldehyde resins prior to the application of the resins. The dispersion is 15% to 65% solids by weight, and commonly 50% by weight, of the active antimicrobial agent. The weight percent addition of the antimicrobial agent is about 0.1% to about 5%, with a preferred range of about 0.3% to about 1.0% of the weight of the melamine resin. Zinc oxide also can be added to the dispersion to stabilize the antimicrobial agent.

In a representative decorative laminate application (e.g. a flooring or countertop article), the laminate is comprised of a high-density core which is generally constructed of one or more layers of fiberboard. A melamine-formaldehyde impregnated printed paper sheet is adhered thereon. The impregnated printed paper can be patterned to have a desired design, such as marble, wood or the like. A melamine-formaldehyde impregnated overlay sheet typically is laid over the paper sheet.

Commonly, the printed paper sheet and the overlay sheet are pre-impregnated with the melamine formaldehyde resin prior to forming the laminate. The fiberboard is usually impregnated with a phenolic or melamine resin. The pre-impregnation of the printed paper and the overlay enables the melamine formaldehyde sufficient time to thoroughly wet-out the substrate, which in turn drives out any remaining entrapped air. Following saturation, the carrier (e.g. water and/or solvent) is dried off, leaving the sheet saturated with the compounded melamine formaldehyde amine.

The melamine formaldehyde resin is usually applied as a compounded resin/water or resin/water/solvent saturate. Solvents commonly used in melamine formaldehyde compositions are rather complex mixtures of two or more solvents and typically include aromatics such as toluene, xylene or Solvessol50 (Exxon); alcohols such as butanol, isobutanol, methanol, ethanol, or isopropanol; esters such as cellosolve acetate, ethyl acetate, or isopropyl acetate; ketones such as isophorone, methyl ethyl ketone, or acetone; alcohol amines such as dimethylethanolamine or dimethylisopropanolamine; and ethers such as butyl cellosolve.

The use of solvents generally is reserved for impregnating difficult-to-saturate paper. Certain grades of kraft paper are either too dense, too hydrophobic, or a combination of the two to be saturated to a sufficient pick up level to achieve the desired properties with a pure water-borne system. More open, porous paper sheets can be saturated with water/latex systems, which generally have the advantage of a lower raw material cost.

Compounding additives, in addition to the antimicrobial agent, can include: surface active agents such as wetting agents, surfactants, deaeratants, and defoamers; anti-blocking agents; catalysts such as PTSA (para-toluene sulfonic acid), MSA (methane sulfonic acid), oxalic acid, ammonium nitrate and ammonium chloride; fillers; pigments; dielectric modifiers; glossing agents; and dyes.

Latent acid catalysts, such as those having a fugitive counter ion, like ammonium nitrate and ammonium chloride, are preferred where the storage time will be lengthy. Generally speaking, the strong acid catalysts are used in melamine formaldehyde systems where the melamine is highly methylated, such as hexamethoxymethylmelamine.

It is necessary only that the antimicrobial agent be added to the overlay to impart antimicrobial properties to the laminate. However, it is contemplated that migration into the printed paper layer may occur.

The representative laminate is formed by combining the treated overlay and underlying materials in a heated press. Standard cure times are from about 15 seconds to several minutes at a temperature of from about 127° C. to about 290° C. Pressures are on the order of from about 1000 pounds per square inch (psi) to about 5000 psi for high pressure laminates and roughly 300-500 psi for low pressure or direct pressure laminates.

Because several of the above antimicrobial agents are capable of reacting with the melamine formaldehyde resin, they should first be blended such that they are effectively encapsulated in a carrier compatible with melamine formaldehyde. This carrier, containing the antimicrobial agent(s), can be added to the melamine formaldehyde, typically in the bath when making solid surface materials or within the resin itself when compressed. Exemplary carriers for blending include emulsifying the antimicrobial in a petroleum process oil (CAS No. 64742-52-5) and 9-octadecenoic acid (CAS No. 112-80-1). Those of skill in the art are readily familiar with typical blending techniques.

Kraft paper was impregnated with a melamine formaldehyde resin either containing no antimicrobial agent or ZO3, a proprietary formulation comprising zinc pyrithione. Additive ZO3 was added at either 0.5% or 0.8% by weight of the melamine resin.

Control and treated paper swatches were tested against Staphylococcus aureus, ATCC 6538 and Klebsiella pneumoniae, ATCC 4352 on Nutrient Agar.

Incubations were at 37° C.±2° C. for 18-24 hours. In all cases, samples pretreated with heat at 170° C. for 30 minutes to remove volatiles, then humidified at 37° C. prior to testing.

Results for K. pneumoniae and S. aureus are displayed in Tables 1 and 2, respectively.

TABLE 1

| | | | Percent | Log |
|---|---|---|---|---|
| | CFU | CFU | Reduction vs. | Reduction vs. |
| Sample | Applied | Recovered | Applied | Untreated |
| Untreated Paper | 207,500 | 636,000 | 0 | |
| Paper with 0.5% | 207,500 | 124,500 | 40 | 0.7 |
| ZO3 | | | | |
| Paper with 0.8% | 207,500 | 8,000 | 96 | 1.9 |
| ZO3 | | | | |

TABLE 2

| | | | Percent | Log |
|---|---|---|---|---|
| Sample | CFU | CFU | Reduction vs. | Reduction vs. |
| Description | Applied | Recovered | Applied | Untreated |
| Untreated Paper | 132,500 | 1,745,500 | 0 | |
| Paper with 0.5% | 132,500 | 100 | 99.9 | 4.2 |
| ZO3 | | | | |
| Paper with 0.8% | 132,500 | 100 | 99.9 | 4.2 |
| ZO3 | | | | |

Control paper samples exhibited no antimicrobial effect; in fact, microbial colonization proceeded unabated on untreated samples. In contrast, samples treated with 0.5% or 0.8% zinc pyrithione formulation showed efficacy against Klebsiella pneumoniae (Table 1). Additive ZO3 showed some efficacy against Staphylococcus aureus at 0.5% (40% reduction v. applied inoculum) and very strong efficacy at 0.8%.

The antimicrobial overlay sheet as described herein was used to form a laminate article, which then was tested against Staphylococcus aureus using a similar procedure. As Table 3 shows, the untreated control laminate had no resistance to microbial colonization. The laminate sample manufactured using an overlay sheet containing 0.8% (by weight of melamine resin) Additive ZO3 demonstrated excellent efficacy against S. aureus.

TABLE 3

| | | | Percent | Log |
|---|---|---|---|---|
| Sample | CFU | CFU | Reduction vs. | Reduction vs. |
| Description | Applied | Recovered | Applied | Untreated |
| Laminate, | 78,000 | 2,615,000 | No Reduction | N/A |
| Untreated | | | | |
| Laminate with | 78,000 | 100 | 99.9 | 4.4 |
| 0.8% ZO3 | | | | |

It is to be understood that the foregoing description and specific embodiments are merely illustrative of the best mode of the invention and the principles thereof, and that various modifications and additions may be made to the apparatus by those skilled in the art, without departing from the spirit and scope of this invention.

What is claimed is:

1. An overlay component, comprising:
a paper article;
a melamine resin substantially impregnated in the paper article; and
a first antimicrobial agent disposed in the melamine resin.

2. The overlay component of claim 1 wherein the first antimicrobial agent is triclosan.

3. The overlay component of claim 1 wherein the first antimicrobial agent is a pyrithione compound.

4. The overlay component of claim 1 wherein the first antimicrobial agent is a silver compound.

5. The overlay component of claim 1 wherein the first antimicrobial agent is an isothiazolone compound or a quaternary ammonium compound.

6. The overlay component of claim 1 wherein the first antimicrobial agent is an azole; poly (hexamethylene biguanide) hydrochloride; 3,4,4′-trichlorocarbanilide; titanium dioxide; barium metaborate monohydrate; ortho phenyl phenol; or diiodomethyl p-tolylsulfone.

7. The overlay component of claim 1 wherein the first antimicrobial agent is present in the melamine resin at a concentration in the range of from about 0.1% to about 5.0% by weight.

8. The overlay component of claim 1 wherein the first antimicrobial agent is present in the melamine resin at a concentration in the range of from about 0.3 to about 1.0% by weight.

9. The overlay component of claim 1 wherein the paper article is provided in a sheet.

10. The overlay component of claim 1 wherein the paper article is provided in a roll.

11. The overlay component of claim 1, further comprising:
a second antimicrobial agent disposed in the melamine resin.

12. The overlay component of claim 11 wherein the first antimicrobial agent is triclosan and the second antimicrobial agent is selected from the group consisting of a pyrithione compound, a silver compound, an isothiazolone compound, and a quaternary ammonium compound.

13. The overlay component of claim 11 wherein the first antimicrobial agent is a pyrithione compound and the second antimicrobial agent is selected from the group consisting of triclosan, a silver compound, an isothiazolone compound, and a quaternary ammonium compound.

14. The overlay component of claim 11 wherein the first antimicrobial agent is one of triclosan or a pyrithione compound, and the second antimicrobial agent is selected from the group consisting of: the other of triclosan or a pyrithione compound, a silver compound, an isothiazolone compound, and a quaternary ammonium compound, an azole, poly (hexamethylene biguanide) hydrochloride, 3,4,4′-trichlorocarbanilide, titanium dioxide, barium metaborate monohydrate, ortho phenyl phenol, and diiodomethyl p-tolylsulfone.

15. A method for manufacturing a laminate article having an antimicrobial melamine surface layer, comprising:
disposing an overlay component adjacent a substrate, wherein the overlay component includes:
a paper article,
a melamine resin substantially impregnated in the paper article, and
a first antimicrobial agent disposed in the melamine resin; and
applying heat and, optionally, pressure to bond the overlay component to the substrate.

16. The method of claim 15 wherein the laminate article is a countertop, a tabletop, a desktop, or a flooring article.

17. The method of claim 15 wherein the first antimicrobial agent is triclosan.

18. The method of claim 15 wherein the first antimicrobial agent is a pyrithione compound.

19. The method of claim 15 wherein the first antimicrobial agent is a silver compound, an isothiazolone compound or a quaternary ammonium compound.

20. The method of claim 15 wherein the overlay component is provided in a sheet.

21. The method of claim 15 wherein the overlay component is provided in a roll.

22. The method of claim 15 wherein the overlay component further includes a second antimicrobial agent disposed in the melamine resin.
